(19) United States
(12) Patent Application Publication
(10) Pub. No.: US 2013/0294062 A1
(43) Pub. Date: Nov. 7, 2013

(54) LED TUBE LAMP

(71) Applicant: CHIA-MAO LI, Taipei City (TW)

(72) Inventor: CHIA-MAO LI, Taipei City (TW)

(21) Appl. No.: 13/466,045

(22) Filed: May 7, 2012

(51) Int. Cl. F21S 4/00

(52) U.S. Cl. 362/225

(57) ABSTRACT

The present disclosure provides an LED tube lamp including a base, a circuit board and at least one light emitting diode arranged on the circuit board. The base includes a connecting surface for mounting the circuit board and two side walls extending from the connecting surface. The two side walls are deformable and rigidly engage the circuit board on the connecting surface.

### BACKGROUND OF THE DISCLOSURE

a) Field of the Disclosure

The present disclosure relates to a lamp, in particularly to an LED tube lamp, which has a base rigidly engaging a circuit board. The lamp is compatible with a T5 or T8 type fluorescent holder.

b) Brief Description of the Related Art

Light emitting diodes (LEDs) have advantages of power saving, long life expectancy and quick response speed. They are extensively used in illuminating field. Nowadays, LED tube lamps are provided by manufacturers for replacing fluorescent tube lamps.

A conventional LED tube lamp has a strip-shaped base for mounting LED modules, and a cover combined with the base for covering the LED modules. Two sets of connecting pins are respectively provided at two ends of the lamp for making electrical connection with two connecting supporters and receiving electrical power that LED modules need.

However, a traditional connection between the LED modules and the base is not secure enough. A usual practice is to apply glue between the LED modules and the base for adhering them. The glue is also capable of dissipating heat generated from the LED module. Although the connection can be easily made, however, the uniformity of the glue applied onto the LED module cannot be precisely controlled. Since the uniformity of the glue is poor, the connection between the LED modules and the base cannot be ensured. When the LED tube lamp is vibrated, shook or impacted, the LED module is easy to loosen or detach from the base. That is a major mechanical failure of the LED module to be dealt with.

In order to solve the failure mentioned above, a novel LED tube lamp which has a rigid connection between the base and the LED modules is needed.

### SUMMARY OF THE DISCLOSURE

The primary objective of the present disclosure is to provide an LED tube lamp, capable of making a rigid connection between the base and the LED modules without any adhesive glue.

The secondary objective of the present disclosure is to provide an LED tube lamp, capable of dissipating heat generated by the LED.

The secondary objective of the present disclosure is to provide an LED tube lamp, capable of dissipating heat generated by the LED.

For achieving the objective mentioned above, the present disclosure provides an LED tube lamp including a base, a circuit board and at least one light emitting diode. The circuit board is mounted to the base. The light emitting diode is arranged on the circuit board. The base includes a connecting surface for mounting the circuit board and two side walls extending from the connecting surface. The two side walls are deformable and rigidly engage the circuit board on the connecting surface.

The LED tube lamp as above mentioned, wherein the base is a one-piece extruded aluminum structure.

The LED tube lamp as above mentioned, wherein the interval between the two side walls is slightly larger than the width of the circuit board.

The LED tube lamp as above mentioned, wherein the base further comprises two connecting grooves respectively formed at two sides of the connecting surface for connecting with a cover.

The LED tube lamp as above mentioned, wherein the two side walls each have an outwardly bent top portion.

There are several advantages of the disclosure in comparison with conventional technology. A circuit board with a light emitting diode is mounted onto the connecting surface and between two side walls. The two side walls can be pressed against the circuit board by a clamp, and then the circuit board is rigidly in engagement with the base. That improves the disadvantage of the poor uniformity of the glue as mentioned above. Two outwardly bent top portions of the side walls can retain the clamp on the side walls while pressing the side walls by the clamp. The circuit board is rigidly in engagement with the base by the two side walls, that makes heat on the circuit board can be effectively dissipated by the base.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1 is a perspective view of an LED tube lamp according to an embodiment of the present disclosure.

FIG. 2 is an exploded view of the LED tube lamp in FIG. 1.

FIG. 3 is a cross sectional view illustrating a configuration before two side walls are pressed.

FIG. 4 is a cross sectional view illustrating a configuration after the two side walls are pressed.

FIG. 5 is a perspective view of an LED tube lamp according to another embodiment of the present disclosure.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

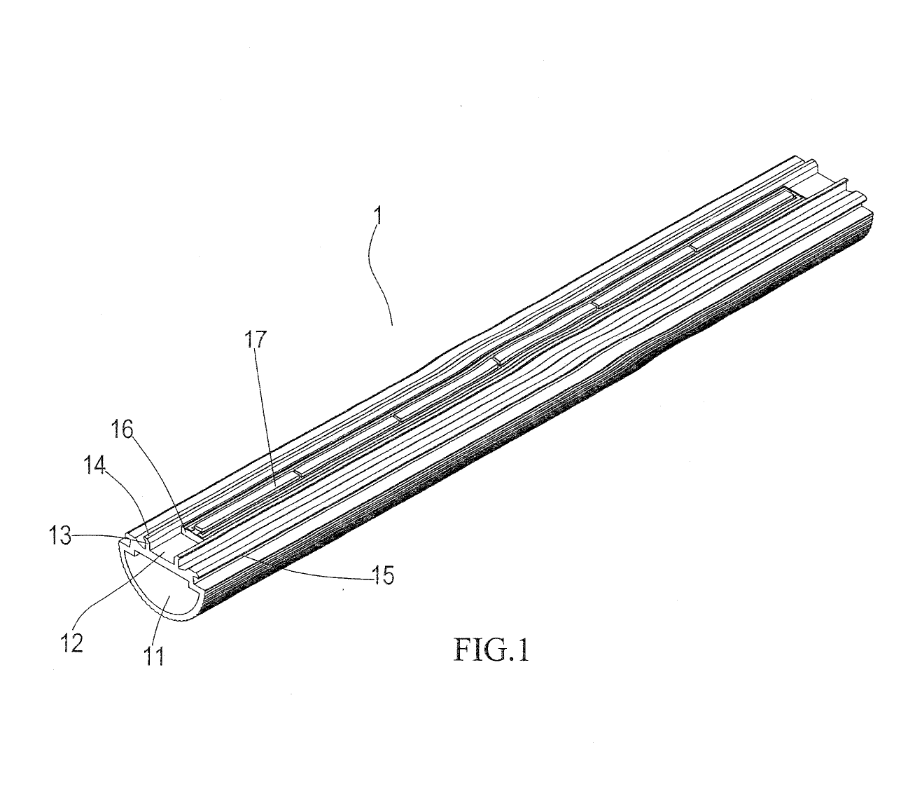

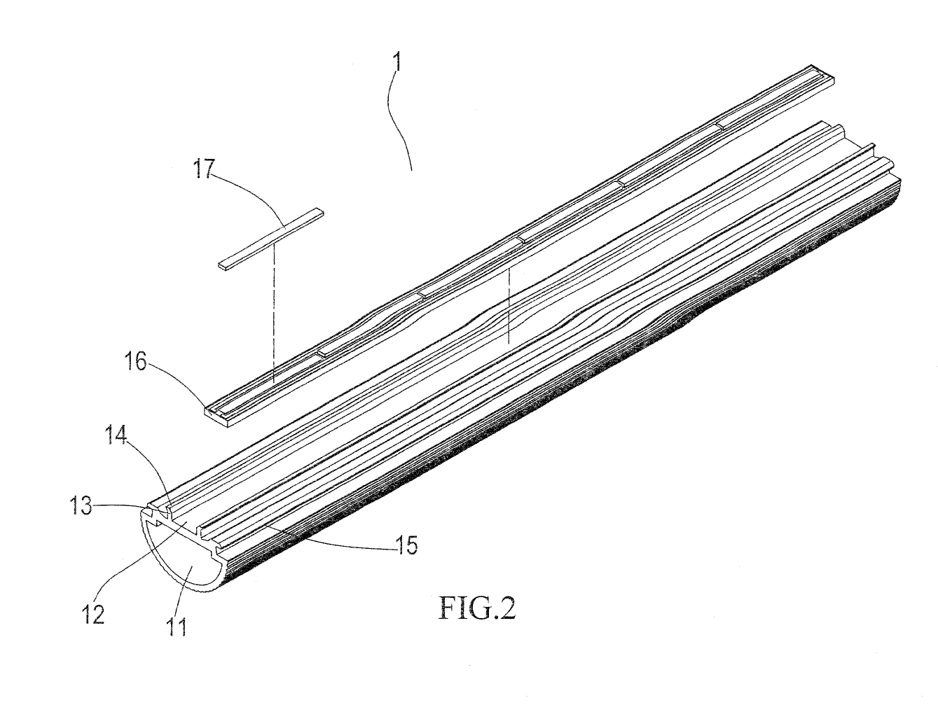

Referring to FIG. 1 and FIG. 2, an embodiment of the disclosure provides an LED tube lamp 1, which includes a base 11, a circuit board 16 mounted to the base 11, and at least one light emitting diode 17 arranged on the circuit board 16. The base 11 has a connecting surface 12 for mounting the circuit board 16 and two side walls 13 extending from the connecting surface 12. The two side walls 13 each have an outwardly bent top portion 14. The base 11 further includes two connecting grooves 15 respectively formed at two sides of the connecting surface 12 for connecting with a cover. Moreover, the base 11 has an arc-shaped portion at its lower side. The arc-shaped portion connects the two connecting grooves 15 and thus makes the base 11 to be a semi-circular shape.

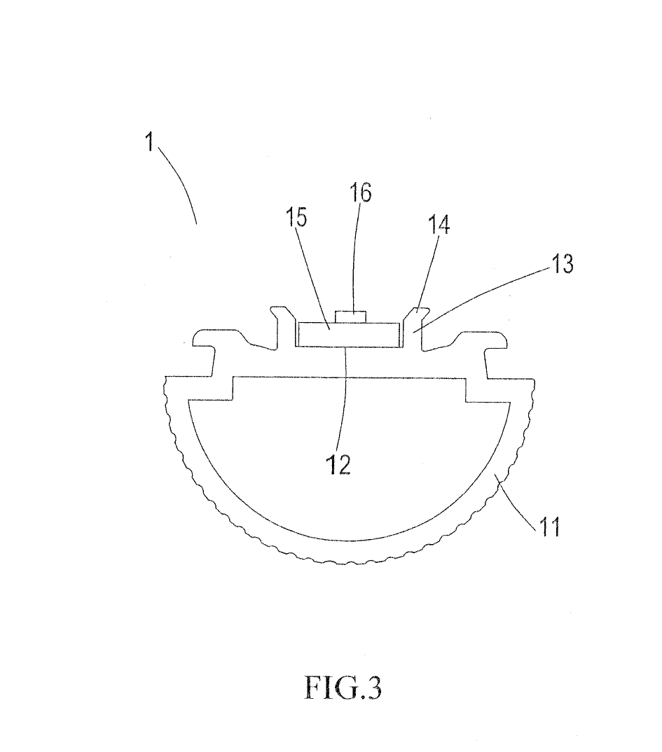

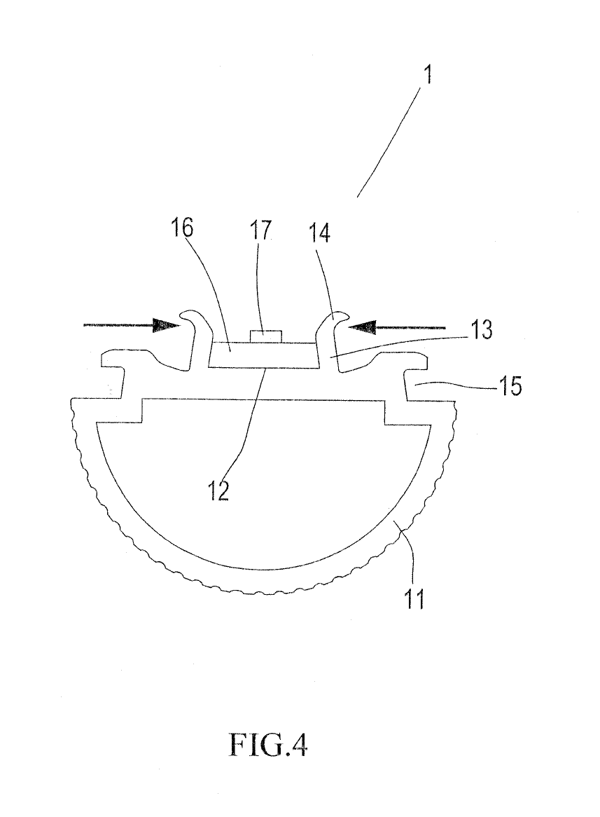

As FIG. 3 shows, the circuit board 16 with the light emitting diode 17 is mounted onto the connecting surface 12 of the base 11 and between the two side walls 13. The bottom side of the circuit board 16 is in contact with the connecting surface 12. In manufacturing, a clamp is put outside the two side walls 13, and then the two side walls 13 are inwardly pressed and deformed by the clamp. As FIG. 4 shows, so that the two side walls 13 are eventually pressed against the circuit board 16. While pressing the side walls 13, the clamp is retained by the outwardly bent top portions 14 of the side walls 13, and will not escape from the side walls 13. Since the two side walls 13 are deformable and pressed against the circuit board 16, the circuit board 16 is rigidly in engagement with the base 11.

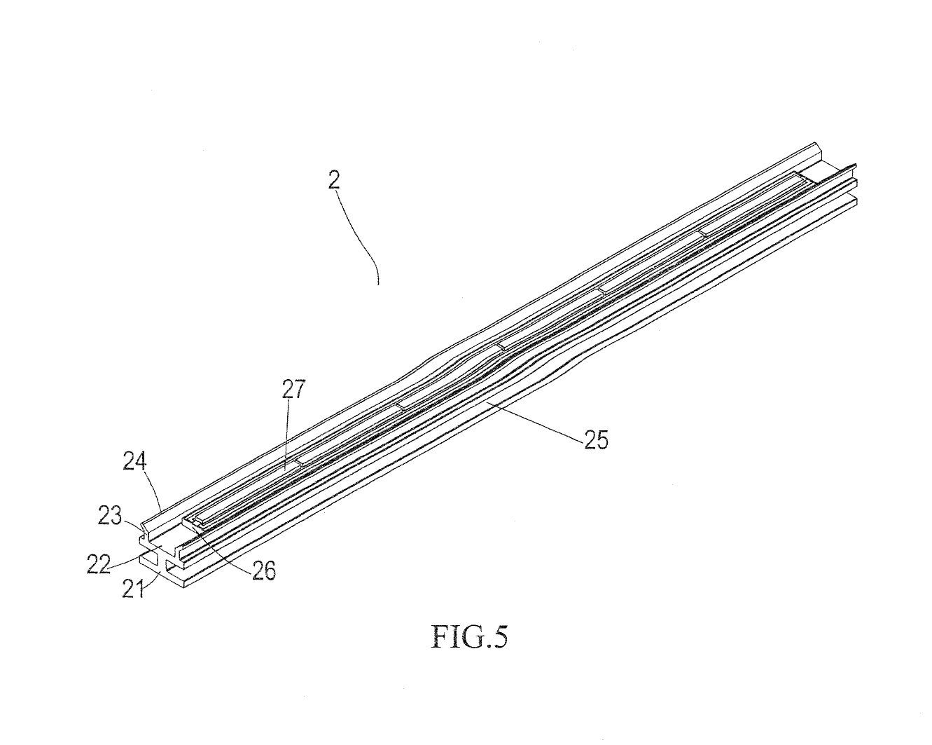

Furthermore, as FIG. 5 shows, another embodiment of the disclosure provides an LED tube lamp 2, which has an H-shaped base 21. The

H-shaped base 21 includes two connecting grooves 25 at two sides thereof for connecting with a cover. The base 21 further includes two side walls 23 extending from two opposite sides of a top surface of the base 21. A connecting surface 22 is formed between the two side walls 23 for mounting the circuit board 26. The two side walls 23 each have an outwardly bent top portion 24. The circuit board 26 with the light emitting diode 27 is mounted onto the connecting surface 22. The bottom side of the circuit board 26 is in contact with the connecting surface 22. A clamp is put outside the two side walls 23, and then the two side walls 23 are inwardly pressed and deformed by the clamp. The two side walls 23 are deformable and pressed against the circuit board 26, the circuit board 26 is rigidly in engagement with the base 21 without any adhesive glue.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof

What is claimed is:

1. AN LED tube lamp, comprising:
a base;
a circuit board mounted to the base; and
at least one light emitting diode arranged on the circuit board,
wherein the base comprises a connecting surface for mounting the circuit board and two side walls extending from the connecting surface,
whereby the two side walls are deformable and rigidly engage the circuit board on the connecting surface.

2. The LED tube lamp as claim 1, wherein the base is a one-piece extruded aluminum structure.

3. The LED tube lamp as claim 1, wherein the interval between the two side walls is slightly larger than the width of the circuit board.

4. The LED tube lamp as claim 1, wherein the base further comprises two connecting grooves respectively formed at two sides of the connecting surface for connecting with a cover.

5. The LED tube lamp as claim 1, wherein the two side walls each have an outwardly bent top portion.
